(19) United States
(12) Patent Application Publication
(10) Pub. No.: US 2026/0277482 A1
(43) Pub. Date: Sep. 17, 2026

(54) MEMORY CONTROLLER AND OPERATING METHOD THEREOF

(71) Applicant: SK hynix Inc., Gyeonggi-do (KR)

(72) Inventors: Jong Bo BAE, Gyeonggi-do (KR); Ku Ik KWON, Gyeonggi-do (KR); Byoung Min JIN, Gyeonggi-do (KR)

(21) Appl. No.: 19/458,945

(22) Filed: Jan. 26, 2026

(30) Foreign Application Priority Data
Mar. 13, 2025 (KR) 10-2025-0032778
Sep. 22, 2025 (KR) 10-2025-0136424

(51) Int. Cl. G06F 3/06

(52) U.S. Cl. CPC G06F 3/0659; G06F 3/0611; G06F 3/064; G06F 3/0679

(57) ABSTRACT

A memory controller according to the present disclosure may be configured to receive a trim command from a host, the trim command instructing to read range data corresponding to a plurality of logical block address ranges, and to sequentially invalidate mapping information corresponding to the plurality of logical block address ranges based on priority information included in the range data.

### CROSS-REFERENCE TO RELATED APPLICATIONS

The present application claims priority under 35 U.S.C. § 119(a) to Korean patent application number 10-2025-0032778, filed on Mar. 13, 2025 and Korean patent application number 10-2025-0136424, filed on Sep. 22, 2025, the entire disclosures of which are incorporated herein by reference.

### BACKGROUND

### 1. Technical Field

The embodiments of the present disclosure relate to a memory controller, and more particularly, to a memory controller and an operating method thereof.

### 2. Related Art

A storage device is a device that stores data under the control of a host device, such as a computer, a smartphone, and a smart pad. The storage device may include a memory device that stores data and a memory controller that controls the operation of the memory device. The memory device may be classified into a volatile memory device and a non-volatile memory device.

When a trim command is received from a host, the memory controller may process the trim command to invalidate the mapping information between logical block addresses and physical block addresses in a mapping table. A trim operation may be performed for logical block address ranges without considering the usage frequency of the logical block address ranges included in the trim command or the possibility of system performance degradation.

### SUMMARY

Embodiments of the present disclosure provide a memory controller that performs trim operations of frequently used logical block address ranges with priority by controlling the execution order of the trim operations for the logical block address ranges based on a priority value included in a trim command, and an operating method thereof.

A memory controller according to embodiments of the present disclosure may be configured to receive a trim command from a host, the trim command instructing to read range data corresponding to a plurality of logical block address ranges, and to sequentially invalidate mapping information corresponding to the plurality of logical block address ranges based on priority information included in the range data.

In some embodiments, the memory controller may further be configured to read the range data corresponding to the plurality of logical block address ranges from a memory of the host, based on a number of ranges defined in a control field included in the trim command.

In some embodiments, when the number of ranges defined in the control field is set to N, N+1 range data may be read from the host.

In some embodiments, the range data may include a start logical block address, a range length, and attribute data of a logical block address range, and the attribute data may include a priority value indicating the priority information.

In some embodiments, the memory controller may further be configured to sort the plurality of logical block address ranges based on the priority value, and to determine an operating method of one of a foreground operation or a background operation based on a size of each of the plurality of logical block address ranges according to a sorted order.

In some embodiments, the size of each of the plurality of logical block address ranges may be determined based on a range length or an invalidation data size of each of the plurality of logical block address ranges.

In some embodiments, the operating method may be determined from a logical block address range with a higher priority value.

In some embodiments, the memory controller may further be configured to determine the operating method of a smaller logical block address range in preference to a larger logical block address range when the plurality of logical block address ranges have the same priority value.

In some embodiments, the memory controller may further be configured to transmit a completion signal indicating completion of the trim command to the host after determining the operating method for a logical block address range with a lowest priority value among sorted results.

In some embodiments, the memory controller may further be configured to determine the operating method of a target logical block address range as the foreground operation when a size of the target logical block address range among the plurality of logical block address ranges is less than a reference value, and to determine the operating method of the target logical block address range as the background operation when the size of the target logical block address range is greater than or equal to the reference value.

In some embodiments, the memory controller may further be configured to register the target logical block address range, for which the operating method is determined as the background operation, in a background queue, and to invalidate the mapping information of each of the logical block address ranges registered in the background queue after transmitting the completion signal.

In some embodiments, the memory controller may further be configured to redetermine the operating method for the target logical block address range as the background operation when, for the target logical block address range for which the operating method is determined as the foreground operation, an accumulated throughput reduction rate up to the target logical block address range exceeds a restricted performance degradation value.

In some embodiments, the memory controller may further be configured to maintain the operating method for the target logical block address range as the foreground operation when, for the target logical block address range for which the operating method is determined as the foreground operation, the accumulated throughput reduction rate up to the target logical block address range does not exceed the restricted performance degradation value.

In some embodiments, the memory controller may further be configured to invalidate the mapping information corresponding to the target logical block address range prior to transmitting the completion signal, for the target logical block address range for which the operating method is determined as the foreground operation.

In some embodiments, the restricted performance degradation value may be a value defined in the control field of the trim command.

According to embodiments of the present disclosure, an operating method of a memory controller managing mapping information indicating a correspondence between a logical block address managed by a host and a physical block address of a memory device, may include receiving a trim command instructing to read range data specifying a plurality of logical block address ranges from the host; reading the range data corresponding to the plurality of logical block address ranges from a memory of the host based on a control field included in the trim command; sorting the plurality of logical block address ranges based on priority information included in the range data; and sequentially invalidating the mapping information corresponding to each of the plurality of logical block address ranges based on a sorted result.

In some embodiments, the operating method may further include selecting a target logical block address range with a highest priority value indicating the priority information according to the sorted result; performing a foreground operation when a size of the target logical block address range is less than a reference value; and performing a background operation when the size of the target logical block address range is greater than or equal to the reference value.

In some embodiments, the operating method may further include transmitting a completion signal indicating a completion status of the trim command to the host when the target logical block address range is the last logical block address range of the sorted result.

In some embodiments, performing the foreground operation may include invalidating the mapping information corresponding to the target logical block address range prior to transmitting the completion signal.

In some embodiments, performing the background operation may include registering the target logical block address range in a background queue; and invalidating the mapping information of each of the logical block address ranges registered in the background queue after transmitting the completion signal.

### BRIEF DESCRIPTION OF THE DRAWINGS

FIG. 1 is a block diagram of an electronic system according to embodiments of the present disclosure.

FIG. 2 is a block diagram illustrating the memory controller of FIG. 1 according to embodiments of the present disclosure.

FIG. 3 is a flowchart illustrating an operating method of a memory controller according to embodiments of the present disclosure.

FIG. 4 is a flowchart illustrating a trim operation of a memory controller according to embodiments of the present disclosure.

FIG. 5 is a diagram illustrating a control field included in a trim command according to embodiments of the present disclosure.

FIG. 6 is a diagram illustrating range data according to embodiments of the present disclosure.

FIG. 7 is a diagram illustrating attribute data according to embodiments of the present disclosure.

FIG. 8 is a diagram for describing a deallocation priority field according to embodiments of the present disclosure.

FIG. 9 is a block diagram illustrating a memory card system to which a storage device according to embodiments of the present disclosure is applied.

FIG. 10 is a block diagram illustrating a solid state drive (SSD) system to which a storage device according to embodiments of the present disclosure is applied.

### DETAILED DESCRIPTION

Hereinafter, various embodiments of the present disclosure will be described in more detail with reference to the accompanying drawings. It should be noted that in the following description, only the parts necessary to understand the operation according to the present disclosure will be described, and descriptions of other parts will be omitted to not obscure the gist of the present disclosure. In addition, the embodiments are not limited to the embodiments described herein and may be embodied in other forms. The embodiments described herein are provided merely to describe in detail enough to enable those skilled in the art to easily implement the technical ideas of the present disclosure.

Terms used herein are for describing specific embodiments and are not intended to limit the embodiments. Throughout this disclosure, in a case where a certain portion "includes", the case means that the portion may further include another component without excluding another component unless otherwise stated. "At least any one of X, Y, and Z" and "at least any one selected from a group consisting of X, Y, and Z" may be interpreted as one X, one Y, one Z, or any combination of two or more of X, Y, and Z (for example, XYZ, XYY, YZ, and ZZ). Here, "and/or" includes all combinations of one or more of corresponding configurations.

Here, terms such as first and second may be used to describe various components, but these components are not limited to these terms. These terms are used to distinguish one component from another component. Therefore, a first component may refer to a second component within a range without departing from the scope disclosed herein.

In this disclosure, some embodiments are described and illustrated in the accompanying drawings in terms of functional blocks, units, components, and/or modules. One of ordinary skill in the art will understand that these blocks, units, components, and/or modules may be physically implemented by electronic (or optical) circuits, such as logic circuits, discrete components, microprocessors, hard-wired circuits, memory elements, wiring connections, and the like, which may be formed using semiconductor-based fabrication techniques or other fabrication techniques. If the blocks, units, components, and/or modules are implemented by microprocessors or other similar hardware, they may be programmed and controlled using software (e.g., microcode) to perform the various functions discussed herein, and may optionally be driven by firmware and/or software.

Further, each block, unit, component, and/or module may be implemented by dedicated hardware, or may be implemented as a combination of dedicated hardware performing some functions and processors (e.g., one or more programmed microprocessors and associated circuit) performing other functions. Further, each block, unit, part, and/or module of some embodiments may be physically separated into two or more interacting and separate blocks, units, parts, and/or modules without departing from the scope of this disclosure. Further, the blocks, units, parts, and/or modules of some embodiments may be physically combined into more complex blocks, units, parts, and/or modules without departing from the scope of this disclosure.

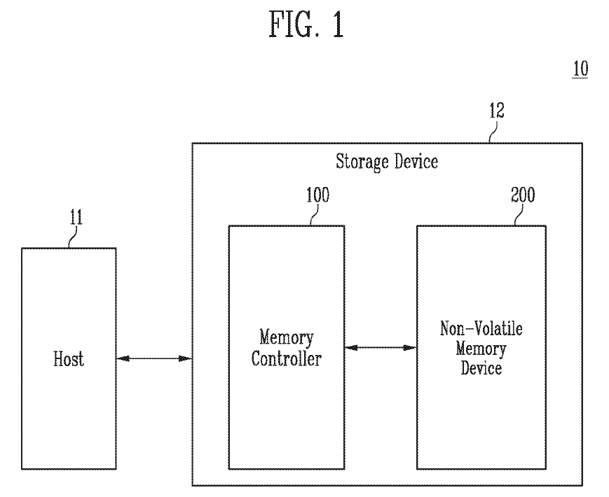

FIG. 1 is a block diagram of an electronic system according to embodiments of the present disclosure.

Referring to FIG. 1, an electronic system 10 may be a computing system configured to process various information and/or store processed information as data. In some embodiments, the electronic system 10 may be implemented as a personal computer (PC), a notebook, a laptop, a server, a workstation, a tablet PC, a smartphone, a digital camera, a dashcam, or the like.

The electronic system 10 may include a host 11 and a storage device 12. The host 11 may control various operations of the electronic system 10. More specifically, the host 11 may control the operations of other components that constitute the electronic system 10. The host 11 may be implemented as a general purpose processor, a dedicated processor, a central processing unit (CPU), or an application processor (AP).

The host 11 may communicate with the storage device 12. For example, the host 11 may request a program operation, a read operation, an erase operation, or the like to the storage device 12. The host 11 may transmit a program command, data, and a logical address for the program operation of the storage device 12, to the storage device 12. The host 11 may transmit a read command and a logical address for the read operation of the storage device 12, to the storage device 12.

The storage device 12 may store data. For example, the storage device 12 may store data under the control of the host 11. In some embodiments, the storage device 12 may include at least one of a solid state device (SSD), an embedded memory, and a removable external memory.

When the storage device 12 is an SSD, the storage device 12 may be a device that follows the Non-Volatile Memory express (NVMe) standard. When the storage device 12 is an embedded memory or a removable external memory, the storage device 12 may be a device that follows the Universal Flash Storage (UFS) or embedded Multi-Media Card (eMMC) standard. The host 11 and the storage device 12 may each generate packets and transmit the generated packets to each other based on the standard protocol employed.

The storage device 12 may include a memory controller 100 and a non-volatile memory device 200. The memory controller 100 may control the operation of the storage device 12. For example, the memory controller 100 may control the operation of the storage device 12 in accordance with an internal policy or in response to a request from the host 11. The memory controller 100 may store data in the non-volatile memory device 200 or read data stored in the non-volatile memory device 200 in accordance with an internal policy or in response to a request from the host 11.

Upon receiving a program command from the host 11, the memory controller 100 may perform a program operation to store data in the non-volatile memory device 200. Upon receiving a read command from the host 11, the memory controller 100 may perform a read operation to read data stored in the non-volatile memory device 200.

Upon receiving a trim command from the host 11, the memory controller 100 may perform processing of the trim command. The processing of the trim command may include a step of decoding a control field included in the trim command to check the number of logical address ranges and a step of reading range data for each logical address range from a buffer memory of the host 11. For example, the control field may be Command Dword 10. A logical address range may be a set of contiguous logical storage units defined by a start logical address and a range length. In an embodiment, the logical storage unit may be a logical block.

The range data may include a start address of the logical address range and the range length, and may also include attribute data indicating additional characteristics of the logical address range. For example, the range data may be referred to as a range definition, and the attribute data may be referred to as a context attribute.

After processing the trim command, the memory controller 100 may initiate the execution of a trim operation. The execution of the trim operation may be a process of deleting mapping information corresponding to each logical address range, and may be an operation that invalidates the mapping information between a logical address (LBA) and a physical address of the non-volatile memory device 200 to indicate that a specific LBA is no longer valid.

Hereinafter, as used herein, "processing a trim command" may refer to an operation of interpreting and decoding the control field and the range data of the trim command received from a host, and "execution of a trim operation" may refer to an operation of invalidating mapping information between a logical address and a physical address in a mapping table to indicate the corresponding logical address as invalid.

The memory controller 100 may perform trim operations in the same order and at the same speed without considering the usage frequency between the plurality of logical address ranges included in the trim command. Therefore, the execution of the trim operation in a relatively frequently used logical address range may be delayed, which may cause unnecessary performance degradation from the perspective of the host 11.

Accordingly, in the present disclosure, an embodiment for controlling the execution order of trim operations between a plurality of logical address ranges by referring to priority information included in attribute data may be described.

The non-volatile memory device 200 may store data under the control of the memory controller 100. The non-volatile memory device 200 may include a plurality of memory blocks. Each of the plurality of memory blocks may include a plurality of memory cells, and the plurality of memory cells may constitute a plurality of strings or a plurality of pages. In some embodiments, a page may be a unit for storing data in the non-volatile memory device 200, or for reading data stored in the non-volatile memory device 200. A memory block may be a unit for erasing data stored in the non-volatile memory device 200.

The non-volatile memory device 200 may move or copy data within the non-volatile memory device 200 to perform various functions. For example, the non-volatile memory device 200 may move or copy data stored in the first memory block to the second memory block to perform at least one of a garbage collection operation, a read reclaim operation, a read refresh operation, a wear leveling operation, and an over-provision operation.

The non-volatile memory device 200 may be NAND flash memory, but the scope of the present disclosure is not limited thereto. The non-volatile memory device 200 may be one of various storage devices that can maintain stored data even when the power supply is cut off, such as phase-change random access memory (PRAM), magnetic random access memory (MRAM), resistive random access memory (RRAM), ferroelectric random access memory (FRAM), and the like.

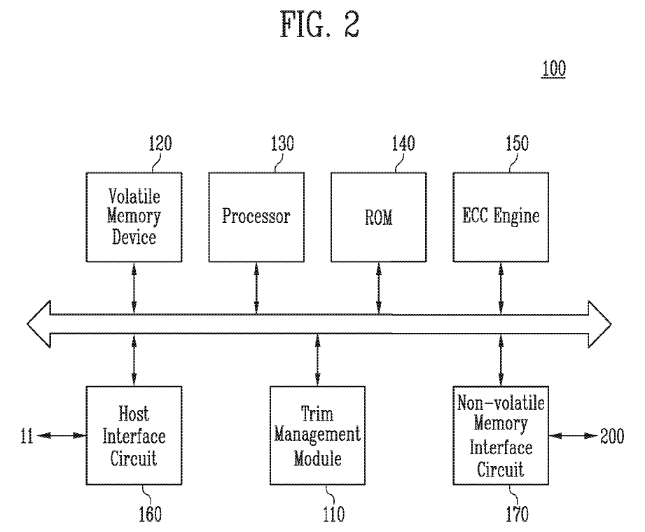

FIG. 2 is a block diagram illustrating the memory controller of FIG. 1 according to embodiments of the present disclosure.

Referring to FIGS. 1 and 2, the memory controller 100 may communicate with the host 11 and the non-volatile memory device 200. The memory controller 100 may include a trim management module 110, a volatile memory device 120, a processor 130, a read only memory (ROM) 140, an error correction code (ECC) engine 150, a host interface circuit 160, and a non-volatile memory interface circuit 170.

In some embodiments, the trim management module 110, the volatile memory device 120, the processor 130, the ROM 140, the ECC engine 150, the host interface circuit 160, and the non-volatile memory interface circuit 170 may be connected to each other through a bus. The bus may serve as a central path for internal operations, including command transmission and data communication.

The trim management module 110 may sort a plurality of logical address ranges according to priority by referring to the priority information included in the attribute data decoded during processing of the trim command. Based on the result sorted according to priority, the processor 130 may sequentially perform trim operations starting from the logical address range with higher priority.

In some embodiments, the trim management module 110 may be implemented as firmware. For example, the non-volatile memory device 200 may store instructions corresponding to the trim management module 110. The processor 130 may load the instructions from the non-volatile memory device 200 into the volatile memory device 120. By executing the loaded instructions, the processor 130 may operate the trim management module 110. The trim management module 110 may operate as part of the memory controller 100.

The volatile memory device 120 may be used as a main memory, a cache memory, or an operational memory of the memory controller 100. For example, the volatile memory device 120 may be implemented as static random access memory (SRAM), dynamic random access memory (DRAM), or the like. In addition, in some embodiments, the volatile memory device 120 may store a plurality of logical address range information sorted according to priority.

The processor 130 may control various operations of the memory controller 100. The processor 130 may execute firmware to control the operation of the memory controller 100. The processor 130 may execute firmware loaded into the volatile memory device 120 at boot-up to control various operations of the memory controller 100 and perform logic operations.

The firmware may be a program executed within the storage device 12 and may include various functional layers. For example, the firmware may include at least one of a flash translation layer (FTL) that performs a conversion function between a logical address required from the host 11 to the storage device 12 and a physical address of the non-volatile memory device 200, a host interface layer (HIL) that interprets commands requested from the host 10 to the non-volatile memory device 200 and transmits them to the flash translation layer (FTL), and a flash interface layer FIL that transmits commands instructed by the flash translation layer (FTL) to the non-volatile memory device 200.

The processor 130 may perform a program operation, a read operation, or an erase operation according to the command received from the host 11. In some embodiments, based on the logic of the trim management module 110, the processor 130 may determine the order in which to perform trim operations between the plurality of logical address ranges according to the priority information.

That is, the trim management module 110 may decode the priority information included in the trim command received from the host 11 and sort the plurality of logical address ranges according to a priority value.

The processor 130 may determine the execution order of trim operations for logical address ranges by comprehensively considering the sorted result and internal resource status. Accordingly, by performing trim operations for logical address ranges with relatively high usage frequency first, and performing trim operations for logical address ranges with low usage frequency when the system load is low, efficient trim operations may be performed while preventing overall performance degradation.

The ROM 140 may be used as a read-only memory to store information required for the operation of memory controller 100. The ECC engine 150 may detect and correct errors in data read from the non-volatile memory device 200. For example, the ECC engine 150 may have a predetermined level of error correction capability. The ECC engine 150 may process data having an error level (e.g., the number of flipped bits) that exceeds the error correction capability as uncorrectable data.

The memory controller 100 may communicate with the host 11 through the host interface circuit 160. In some embodiments, the host interface circuit 160 may be implemented based on at least one of various interfaces, such as a Serial ATA (SATA) interface, a Peripheral Component Interconnect Express (PCIe) interface, a Serial Attached SCSI (SAS) interface, an Embedded Multi Media Card (eMMC) interface, a Universal Flash Storage (UFS) interface, and the like.

The memory controller 100 may communicate with the non-volatile memory device 200 through the non-volatile memory interface circuit 170. In some embodiments, the non-volatile memory interface circuit 170 may be implemented based on a NAND Flash interface such as Toggle, and Open NAND Flash Interface (ONFI).

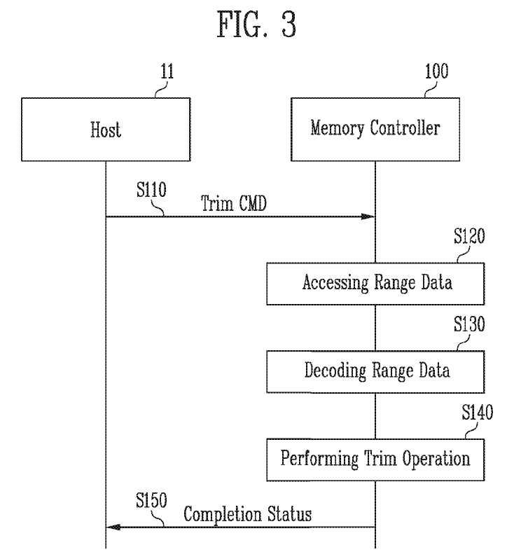

FIG. 3 is a flowchart illustrating an operating method of a memory controller according to embodiments of the present disclosure.

Referring to FIG. 3, a process in which the memory controller 100 processes a trim command received from the host 11 and performs a trim operation for logical address ranges is shown.

At operation S110, the host 11 may transmit a trim command to the memory controller 100. The trim command may include a control field. The number of logical address ranges and a restricted performance degradation value may be defined in the control field. In an embodiment, prior to operation S110, the host 11 may transmit an enable command to the memory controller 100 to enable a priority-based trim feature according to the present disclosure. The memory controller 100 may interpret the reserved fields of the control field and the range data as valid parameters only when the priority-based trim feature is enabled. If the feature is not enabled, the memory controller 100 may ignore the values in the reserved fields and may perform a conventional trim operation.

When the memory controller 100 performs a trim operation, operations such as updating the mapping table may delay the read operation or the program operation of the host 11, which may degrade the overall system performance. Accordingly, the host 11 may transmit, as the restricted performance degradation value, an upper limit of acceptable performance degradation to the memory controller 100. Here, the term “performance” in the restricted performance degradation value is based on the overall data processing throughput of the storage device 12 as viewed from the host 11, and therefore the restricted performance degradation value may also be interpreted as an upper limit of a cumulative throughput reduction rate caused by the trim operations. The cumulative throughput reduction rate will be described later in detail.

The restricted performance degradation value may be a parameter for controlling the system performance degradation that may occur due to the trim operation for the logical address ranges. For example, the restricted performance degradation value may be defined as a percentage value between 0 and 100, and a larger value may indicate that relatively larger performance degradation is allowed.

In some embodiments, the memory controller 100 may refer to the restricted performance degradation value to determine an operating method of the logical address range. The operating method may include a foreground operation and a background operation. The foreground operation may mean an operation in which a trim operation of a logical address range is executed before operation S150, and the background operation may mean an operation in which a trim operation of a logical address range is executed after operation S150.

In operation S120, the memory controller 100 may read the range data for the logical address ranges from the memory of the host 11. In some embodiments, based on the number of ranges defined in the control field included in the trim command, the memory controller 100 may read plural pieces of range data stored in the memory of the host 11 in a direct memory access (DMA) manner.

At operation S130, the memory controller 100 may decode the read range data. The memory controller 100 may decode the range data to obtain attribute data. In some embodiments, the trim management module 110 may sort a plurality of logical address ranges according to priority by referring to priority information included in the attribute data.

At operation S140, the processor 130 may perform trim operations for the logical address ranges by comprehensively considering the sorted result and the internal resource status of the memory controller 100. For example, a first logical address range with a higher priority may be invalidated first, and then a second logical address range with a higher priority may be invalidated sequentially.

In operation S150, the memory controller 100 may transmit a completion signal indicating the completion status of the trim command to the host 11.

Thus, the memory controller 100 according to embodiments of the present disclosure may utilize the priority information provided by the host 11 as a hint rather than a simple instruction and combine it with the internal resource status to ultimately control the order in which trim operations are executed. This enables efficient trim operations while minimizing the overall system performance degradation.

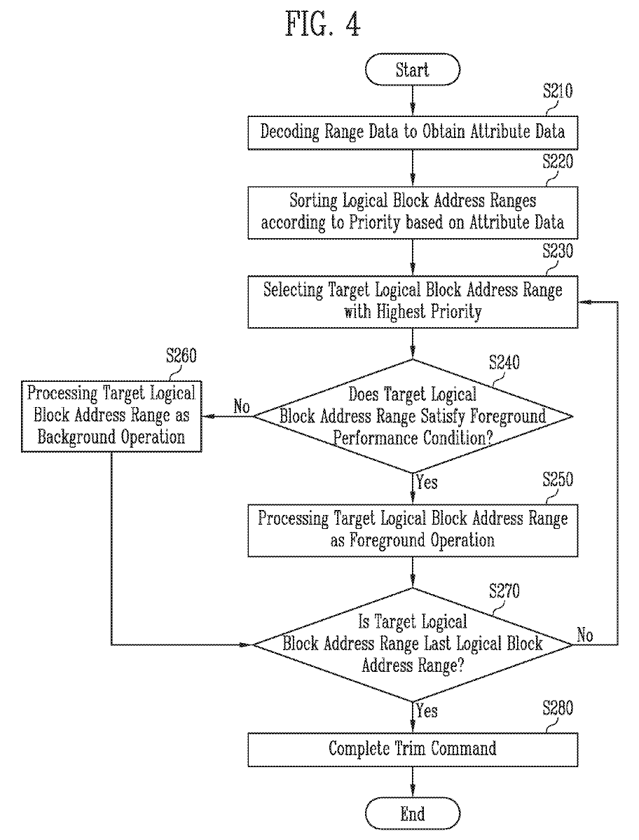

FIG. 4 is a flowchart illustrating a trim operation of a memory controller according to embodiments of the present disclosure.

Referring to FIGS. 3 and 4, an operating method of a memory controller 100 that controls the order in which trim operations are executed for a plurality of logical address ranges based on priority information provided by the host 11 is shown. The memory controller 100 may perform the operating method described in FIG. 4 based on the trim management module 110 and the processor 130 of FIG. 2.

Further, operation S210 described in FIG. 4 may correspond to operation S130 of FIG. 3, operations S220 to S270 described in FIG. 4 may be included in operation S140 of FIG. 3, and operation S280 described in FIG. 4 may correspond to operation S150 of FIG. 3. Accordingly, redundant descriptions are omitted.

In operation S210, the memory controller 100 may decode range data received from the host 11 to obtain attribute data.

At operation S220, the memory controller 100 may sort a plurality of logical address ranges according to priority based on priority information included in the attribute data. In some embodiments, among logical address ranges with the same priority, the memory controller 100 may arrange a smaller logical address range earlier in the sorting order than a larger logical address range.

In this disclosure, the size of a logical address range may refer to, for example, a range length defined in the range data (i.e., the number of logical addresses included in a range) or the size of invalidation data corresponding to a logical address range.

The "size of invalidation data" may refer to the amount of total data included in the logical address range that is invalidated by the trim operation. For example, the size of the invalidation data may be calculated as a product of the length of the logical address range and the size of a logical block unit (e.g., 512 bytes, 4 kilobytes, etc.).

For example, when the first logical address range and the second logical address range have the same priority, and the length of the first logical address range is 100 logical blocks and the length of the second logical address range is 500 logical blocks, the first logical address range may be determined to be a smaller range and may be placed at the front of the sorting order. Therefore, the first logical address range may be selected before the second logical address range when selecting a target range in operation S230.

At operation S230, the memory controller 100 may select a logical address range with the highest priority as a target logical address range based on the plurality of logical address ranges that are sorted. For example, among the plurality of logical address ranges, the first logical address range with the highest priority may be selected as the target logical address range.

The target logical address range may be a range with the highest priority selected from among the plurality of logical address ranges sorted according to priority, and may be a target for the processor 130 to perform the trim operation as a foreground operation or a background operation by comprehensively considering the internal resource status.

Then, after a trim operation is performed for the target logical address range, the next logical address range with the highest priority among the remaining logical address ranges may be selected as a new target logical address range.

At operation S240, the memory controller 100 may determine whether the trim operation for the target logical address range satisfies a foreground performance condition. The foreground performance condition may mean a criterion for determining whether to perform the foreground operation based on the relationship between the size of the target logical address range and the restricted performance degradation value. The foreground performance condition may be evaluated in two stages. In a first stage, the memory controller 100 temporarily determines that the target logical block address range satisfies the foreground performance condition when the size of the target logical block address range is smaller than at least one reference value (e.g., the first reference value for the range length or the second reference value for the size of invalidation data). In a second stage, the memory controller 100 maintains or changes this temporary determination by further referring to the restricted performance degradation value and the cumulative throughput reduction rate as described below.

In some embodiments, the memory controller 100 may first determine whether the foreground performance condition is satisfied based on the size of the target logical address range and a reference value. The reference value may include one or more values. In an embodiment, the reference value may be dynamically determined based on the current available capacity of operational memory or the number of empty slots in the background queue within the memory controller 100. For instance, if the background queue is near full capacity, the memory controller 100 may increase the reference value to force more ranges to be processed as foreground operations, thereby preventing a queue overflow. Conversely, if the host interface circuit 160 is idle, the reference value may be adjusted to process larger ranges in the foreground.

For example, when the length of the target logical address range (i.e., the number of logical addresses included therein) is less than a first reference value, or when the size of invalidating data in the target logical address range is less than a second reference value, the memory controller 100 may temporarily determine that the target logical address range satisfies the foreground performance condition.

When the length of the target logical address range is greater than or equal to the first reference value, or the size of the invalidation data in the target logical address range is greater than or equal to the second reference value, the memory controller 100 may determine that the target logical address range does not satisfy the foreground performance condition. Accordingly, the memory controller 100 may perform operation S260.

The first reference value and the second reference value may be set according to an internal policy of the memory controller 100. For example, the first reference value and the second reference value may be determined based on factors such as the number of channels in the non-volatile memory device 200, parallelism capacity, bus bandwidth, cache memory size, or expected system load conditions.

The first reference value and the second reference value may be determined to be different values depending on comparison target, but the first reference value and the second reference value may be the same in that they are values that serve as a reference for determining whether the target logical address range satisfies the foreground performance condition.

In some embodiments, when the trim operation is executed as the foreground operation, the memory controller 100 may consider that the overall system throughput may decrease because the read operation or the program operation of the host 11 is delayed due to operations such as updating the mapping table.

Accordingly, the memory controller 100 may maintain the operation determined to satisfy the foreground performance condition or change it to satisfy the background performance condition by referring to the restricted performance degradation value.

The restricted performance degradation value may be defined as a percentage value between 0 and 100, which may be a hint indicating an upper limit of acceptable system throughput degradation due to the trim operation. For example, when the restricted performance degradation value is set to 20%, the memory controller 100 may control the overall system throughput so that it does not decrease by more than 20% compared to the normal throughput even when the trim operation is executed as the foreground operation.

A throughput reduction rate may refer to a rate at which the overall system throughput is reduced due to execution of the trim operation. For example, the throughput reduction rate may be calculated by setting a reference throughput (e.g., host I/O throughput per unit time without the trim operation) when no trim operation is performed to 100% and dividing, by the reference throughput, a difference between the reference throughput and the throughput when the trim operation is executed by the reference throughput. In some embodiments, the memory controller 100 may, prior to execution of a trim operation for a target logical block address range, estimate an expected throughput reduction rate based on a size of the target logical block address range and an internal resource state of the memory controller 100.

When the cumulative throughput reduction rate including the target logical address range does not exceed the restricted performance degradation value, the memory controller 100 may maintain that the target logical address range satisfies the foreground performance condition and perform operation S250. Accordingly, the trim operation for the target logical block address range may be finally performed as the foreground operation only when both of the followings are satisfied: (i) the size-based condition with respect to the first and/or second reference value is met, and (ii) the cumulative throughput reduction rate including the target logical address range does not exceed the restricted performance degradation value.

When the cumulative throughput reduction rate including the target logical address range exceeds the restricted performance degradation value, the memory controller 100 may redetermine that the target logical address range does not satisfy the foreground performance condition but satisfies the background performance condition, and perform operation S260.

For example, when the restricted performance degradation value is set to 20% in a system with a throughput of 100 MB/s, the memory controller 100 may control the system throughput not to be reduced to less than 80 MB/s by the trim operation.

In the present disclosure, the cumulative throughput reduction rate is defined as a total value obtained by summing the estimated throughput reduction rates of all logical block address ranges for which the processing has been determined as the foreground operation, inclusive of the estimated throughput reduction rate of the current target logical block address range. When the cumulative throughput reduction rate is expected to be 15% as a result of the first logical address range and the second logical address range being executed as foreground operation, and the throughput reduction rate expected to be 4% as a result of performing a third logical address range, the cumulative throughput reduction rate becomes 19%, which is within the restricted performance degradation value, and therefore the memory controller 100 may perform the third logical address range as the foreground operation.

However, when the throughput reduction rate expected from performing the third logical address range is 10%, the cumulative throughput reduction rate becomes 25%, which exceeds the restricted performance degradation value, so the third logical address range may be determined not to satisfy the foreground performance condition and may be switched to the background operation.

At operation S250, when the target logical address range satisfies the foreground performance condition, the memory controller 100 may execute the trim operation for the target logical address range as the foreground operation.

The memory controller 100 may invalidate the mapping information between the target logical address range and the physical address in the mapping table to indicate that a specific logical address is no longer valid, thereby allowing the trim operation for the target logical address range to be executed as the foreground operation.

At operation S260, when the target logical address range does not satisfy the foreground performance condition, the memory controller 100 may register the target logical address range in a background queue to perform the background operation.

When the target logical address range is registered in the background queue, the trim operation for the target logical address range may not be performed immediately, but may be performed sequentially after the memory controller 100 transmits a completion signal to the host 11.

For example, after the memory controller 100 transmits the completion signal, a trim operation may be executed sequentially starting from a range with a higher priority value for a plurality of logical address ranges registered in the background queue.

However, in some embodiments, the memory controller 100 may also consider priority when executing a trim operation for the target logical address range registered in the background queue. For example, when the first logical address range has a higher priority than the second logical address range, the memory controller 100 may perform the trim operation for the first logical address range before the second logical address range when the first logical address range is registered in the background queue and the second logical address range is determined to be performed as the foreground operation.

At operation S270, the memory controller 100 may determine whether the current target logical address range is the last logical address range included in the trim command. The "last logical address range" may refer to a logical address range with the lowest priority information among the result in which the plurality of logical address ranges included in the trim command received from the host 11 is sorted according to priority.

The "last logical address range" may mean a range that is located at the last order among the result in which the plurality of logical address ranges included in the trim command received from the host 11 is sorted according to priority.

When the target logical address range is not the last logical address range, the memory controller 100 may return to operation S230, select a logical address range with the highest priority among the remaining logical address ranges as a new target logical address range, and repeat operations S240 to S260.

For example, when the first logical address range, the second logical address range, and the third logical address range are included in the trim command, and the first to third logical address ranges are sequentially sorted according to priority such that the first logical address range has the highest priority, the memory controller 100 may select the first logical address range as the target logical address range and perform operations S240 to S270.

Then, when performing operation S230 again, the memory controller 100 may select the second logical address range with the highest priority among the remaining second logical address range and the third logical address range as a new target logical address range.

That is, the memory controller 100 may select a logical address range with the highest priority among the remaining logical address ranges as a new target logical address range after the trim operation for the target logical address range is executed.

When the target logical address range is the last logical address range, the memory controller 100 may perform operation S280.

In operation S280, the memory controller 100 may complete the trim command. That is, the memory controller 100 may complete processing of the trim command for each of the plurality of logical address ranges included in the trim command received from the host 11, and after completing the execution of the trim operations for the logical address ranges determined to be performed as foreground operations, may transmit a completion signal indicating the completion status of the trim command to the host 11.

In some embodiments, after the memory controller 100 determines the operating method of each of the plurality of logical address ranges included in the trim command received from the host 11 as the foreground operation or the background operation, the memory controller 100 may transmit a completion signal indicating the completion status of the trim command to the host 11. For example, after determining the operating method for the last logical address range, the memory controller 100 may transmit a completion signal to the host 11.

Accordingly, the memory controller 100 according to embodiments of the present disclosure may sort a plurality of logical address ranges according to priority by referring to the priority information received from the host 11, and may execute a trim operation for each of the sorted ranges as either a foreground operation or a background operation, by considering the internal resource status.

The memory controller 100 may prevent unnecessary performance degradation by preferentially performing trimming operations for logical address ranges with relatively high usage frequency. Accordingly, the memory controller 100 according to embodiments of the present disclosure may improve the efficiency of executing trim operations, thereby maintaining the overall system performance in a stable manner.

Although the embodiments of the present disclosure has described a method for determining the execution order between a plurality of logical address ranges included in a single trim command, the embodiments are not limited thereto and may be similarly applied to a method for determining the execution order between a plurality of logical address ranges included in a plurality of trim commands.

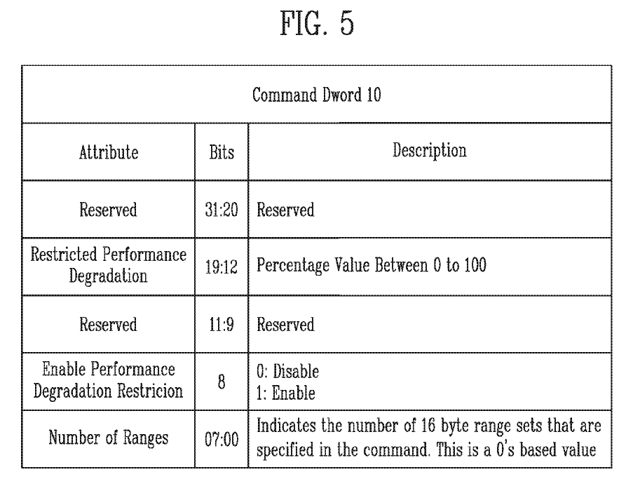

Hereinafter, embodiments of the present disclosure will be described with reference to FIGS. 5-8, based on a structure defined in accordance with the NVMe standard. More specifically, a method for determining the execution order of trim operations between a plurality of logical address ranges included in a single trim command is described, in which priority information is assigned to a field as a reserved field in the NVMe standard and unused, and the priority information is utilized as a hint during the execution of trim operations.

FIG. 5 is a diagram illustrating a control field included in a trim command according to embodiments of the present disclosure.

Referring to FIG. 5, the control field may have a command dword 10 structure as defined in the NVMe standard. In some embodiments of the present disclosure, when receiving a trim command from the host 11, the memory controller 100 may process the trim command and obtain information included in a control field.

Specifically, bit 31 to bit 20 may be reserved fields, which may be undefined.

Bit 19 to bit 12 may be restricted performance degradation fields, which may be defined as a percentage value between 0 and 100. In some embodiments of the present disclosure, the restricted performance degradation value may be used as a parameter to indicate an upper limit of acceptable system performance degradation when performing the trim operation. A larger value may indicate that a relatively larger performance degradation is acceptable.

In the NVMe standard, bit 19 to bit 12 are defined as reserved fields, but in embodiments of the present disclosure, these bits may be used extensively as a field to transmit a parameter for specifying the upper limit of acceptable system performance degradation when performing the trim operation.

Referring to operation S240 of FIG. 4, the memory controller 100 may determine, based on the restricted performance degradation value, whether to immediately perform a trim operation of the target logical address range as the foreground operation or to delay the trim operation as the background operation.

Bit 11 to bit 9 may be reserved fields, which may be undefined.

Bit 8 may be an enable performance degradation restriction field. When set to a value of 0, the restricted performance degradation field may be disabled, and when set to a value of 1, the restricted performance degradation field may be enabled. That is, the enable performance degradation restriction field may be used as a flag to indicate whether the host 11 intends to utilize the restricted performance degradation field.

In some embodiments, when the restricted performance degradation field is disabled, the operation in operation S240 of FIG. 4 in which the memory controller 100 determines whether to immediately perform the trim operation of the target logical address range as the foreground operation based on the restricted performance degradation value or to delay the trim operation as the background operation, may be omitted.

Bit 7 to bit 0 may indicate the number of ranges. The number of ranges may define the number of logical address ranges included in the trim command. The field may be interpreted as a zero-based value. That is, when the number of ranges is 'N', the number of logical address ranges actually included therein may be 'N+1'.

In some embodiments, by checking the number of ranges included in the control field, the memory controller 100 may determine the extent of range data to be received from the host 11 or read from the buffer memory of the host 11.

For example, when the number of ranges in the control field is set to '2', the memory controller 100 may use a total of three logical address ranges as targets of the trim command. Accordingly, the memory controller 100 may read range data corresponding to three logical address ranges from the buffer memory of the host 11.

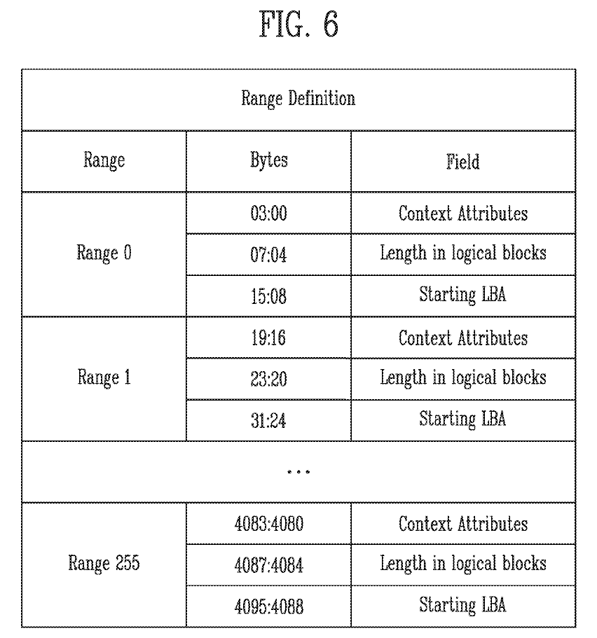

FIG. 6 is a diagram illustrating range data according to embodiments of the present disclosure.

Referring to FIG. 6, range data in accordance with the NVMe standard may be described. As used herein, the term range data may correspond to the range definition as defined in the NVMe standard, and attribute data included in the range data may correspond to context attributes as defined in the NVMe standard.

In some embodiments, the memory controller 100 may sequentially read and interpret the range data shown in FIG. 6 by checking the number of ranges included in the control field of FIG. 5. That is, when the number of ranges in the control field is set to 'N', the memory controller 100 may parse (N+1) pieces of range data according to the structure of FIG. 6 to determine the range and attribute context attributes for each logical address range.

Accordingly, in FIG. 6 below, a case in which the range data and attribute data according to embodiments of the present disclosure have the range definition and context attributes structure of the NVMe standard is described.

The range definition may include information about the plurality of logical address ranges. Each logical address range may be defined as fields that include at least one of context attributes, length in logical blocks, and starting LBA.

For example, Range 0 may include a context attributes field corresponding to byte 0 to byte 3, a range length field corresponding to byte 4 to byte 7, and the start logical address field corresponding to byte 8 to byte 15. Range 1 may include a context attributes field corresponding to bytes 16 to byte 19, a range length field corresponding to byte 20 to byte 23, and a start logical address field corresponding to byte 24 to byte 31. This structure may be repeated up to Range 255.

Thus, each of Range 0, Range 1, and Range 255 shown in FIG. 6 may correspond to a logical address range as described in the present disclosure. That is, each range within the range definition as defined in the NVMe standard may be a logical address range in accordance with embodiments of the present disclosure.

The memory controller 100 may decode the context attributes field included in the logical address range to obtain priority information and may sort the logical address ranges according to the obtained priority information.

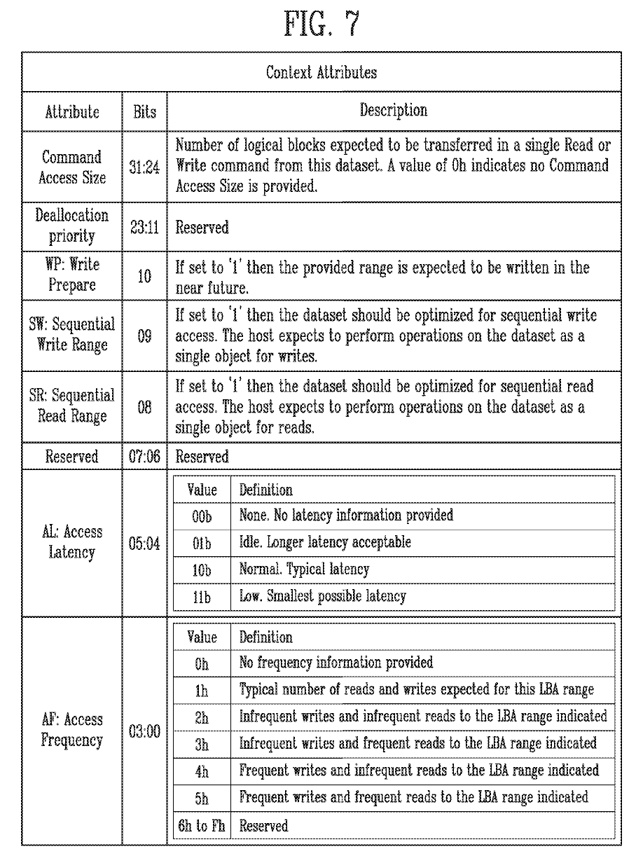

The context attributes field may be attribute data that defines additional characteristics corresponding to the logical address range. In some embodiments, the context attributes may include priority information for determining the execution order of trim commands. A more detailed description of the context attributes field will be described below with reference to FIG. 7.

The range length field may be data indicating the number of logical blocks included in the logical address range. The range length may define the size of the corresponding logical address range and may be compared with the first reference value to determine whether a trim operation is the foreground performance condition.

The start logical address field may indicate the start position of the logical address range. That is, the range data may define the range of the logical address range by the start logical address and the range length.

FIG. 7 is a diagram illustrating attribute data according to embodiments of the present disclosure.

Referring to FIG. 7, the context attributes structure defined in the NVMe standard may be described. In this disclosure, the term attribute data is used, which may correspond to context attributes defined in the NVMe standard.

Accordingly, in FIG. 7 below, a case in which attributes data according to embodiments of the present disclosure has the context attributes structure of the NVMe standard is described.

The context attributes may be data that defines additional characteristics for the logical address range. The context attributes may consist of a plurality of bit fields, each of which may indicate characteristics that the host assigns to a specific logical address range.

For example, bit 31 to bit 24 may define a command access size. This may be a value indicating the number of logical blocks expected to be transmitted by a single read or write command. A value of 0 may indicate that no specific command access size is provided for that range.

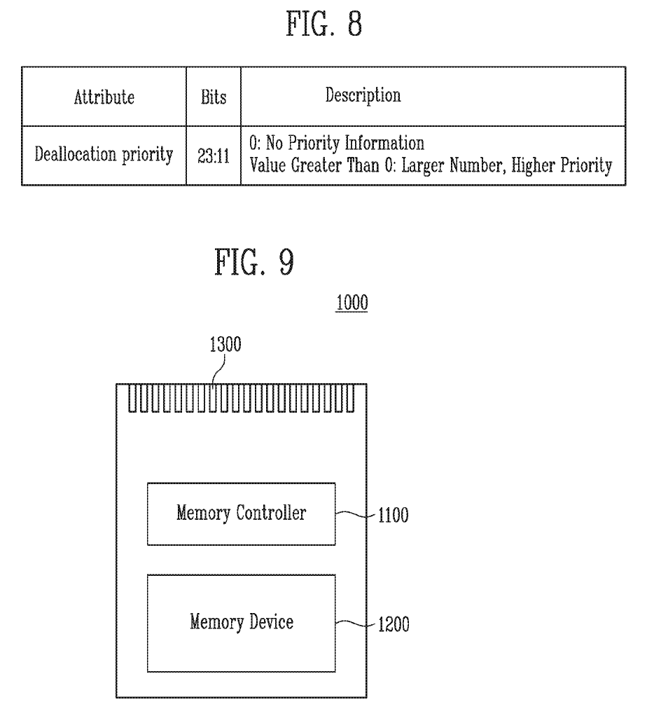

Bit 23 to bit 11 may define a deallocation priority. Although the NVMe standard defines this bit as a reserved area, embodiments of the present disclosure may utilize this field to provide priority information for controlling the order in which trim operations are executed between a plurality of logical address ranges. A more specific description of this will be provided below with reference to FIG. 8.

Bit 10 may be a write prepare field, which, when set to a value of 1, may indicate that the corresponding logical address range is expected to perform a write operation in the near future.

Bit 9 may be a sequential write range field, which, when set to a value of 1, may indicate that sequential write accesses should be optimized for that range.

Bit 8 may be a sequential read range field, which, when set to a value of 1, may indicate that sequential read accesses should be optimized for that range.

Bit 7 to bit 6 may be reserved fields, which may be undefined.

Bit 5 to bit 4 may be fields indicating an access latency. For example, a value of 00b may indicate that no latency information is provided, a value of 01b may indicate that relatively long latencies are acceptable, a value of 10b may indicate a typical level of latency, and a value of 11b may indicate that as low a latency as possible is required.

Bit 3 to bit 0 may be fields indicating an access frequency. For example, a value of 0h may indicate that no frequency information is provided, a value of 1h may indicate that a typical number of reads and writes is expected, values of 2h to 5h may indicate that the frequency characteristics of reads and writes may be defined by range. The ranges 6h to Fh may be undefined.

FIG. 8 is a diagram for describing a deallocation priority field according to embodiments of the present disclosure.

Referring to FIG. 8, the deallocation priority field may be defined as bit 23 to bit 11 of the context attributes. Although the NVMe standard defines this field as a reserved area, embodiments of the present disclosure may utilize this field to indicate priority information for controlling the order in which trim operations are executed for the logical address ranges.

Specifically, the priority information may be defined by a deallocation priority field value. When the deallocation priority field value is 0, the logical address range may be interpreted as including no priority information.

When the deallocation priority field value is greater than 0, a higher value may indicate a higher priority for the logical address range. For example, a logical address range with a value of 3 may be stored in a higher order than a logical address range with a value of 1. The deallocation priority field value may refer to a priority value that represents priority information in the present disclosure.

Thus, referring to FIGS. 5-8, the memory controller may check the number of ranges included in the control field (command dword 10 defined in the NVMe standard) and read the corresponding (N+1) pieces of range data (range definition defined in the NVMe standard) from the buffer memory of the host 11.

The memory controller may decode the attribute data (context attributes defined in the NVMe standard) included in each range data piece to check the deallocation priority field value and compare the checked values to sort the N+1 logical address ranges according to priority.

For example, when the number of ranges in the control field is set to '2', a single trim command may include three logical address ranges, and as a result of sorting the three logical address ranges according to priority value, a logical address range with the lowest priority value may be determined as the last logical address range.

Thereafter, the memory controller may control the final execution order by sequentially performing trim operations starting from the logical address range with the highest priority based on the sorted result, or by performing some ranges as the background operation depending on the internal resource status and the restricted performance degradation value.

As such, the deallocation priority field according to embodiments of the present disclosure may be used to represent priority information provided by the host by utilizing a bit range defined as the reserved area in the NVMe standard. This allows the trim operation to be performed preferentially for the logical address range frequently used by the host, which may contribute to preventing overall system performance degradation.

FIG. 9 is a block diagram illustrating a memory card system to which a storage device according to embodiments of the present disclosure is applied.

Referring to FIG. 9, a memory card system 1000 may include a memory controller 1100, a memory device 1200, and a connector 1300.

The memory controller 1100 may be connected to the memory device 1200. The memory controller 1100 may be configured to access the memory device 1200. For example, the memory controller 1100 may be configured to control read, write, erase, and background operations of the memory device 1200. The memory controller 1100 may be configured to provide an interface between the memory device 1200 and a host. The memory controller 1100 may be configured to drive firmware for controlling the memory device 1200. The memory device 1200 may be implemented identically to the non-volatile memory device 200 of FIG. 1 described with reference to FIG. 1.

For example, the memory controller 1100 may include components such as a random access memory (RAM), a processing unit, a host interface, a memory interface, and an error corrector.

The memory controller 1100 may communicate with an external device through the connector 1300. The memory controller 1100 may communicate with an external device (e.g., a host) according to a predetermined communication standard. In an embodiment, the memory controller 1100 may be configured to communicate with an external device (e.g., a host) through at least one of various communication standards or interfaces, such as USB (Universal Serial Bus), MMC (Multi-Media Card), eMMC (embedded MMC), PCI (peripheral component interconnection), PCI-E (PCI-express), ATA (Advanced Technology Attachment), Serial-ATA, Parallel-ATA, SCSI (small computer system interface), ESDI (enhanced small disk interface), IDE (Integrated Drive Electronics), Firewire, UFS (Universal Flash Storage), WIFI, Bluetooth, NVMe, and the like. For example, the connector 1300 may be defined by at least one of the various communication standards or interfaces described above.

For example, the memory device 1200 may be implemented with various non-volatile memory devices, such as electrically erasable and programmable ROM (EEPROM), NAND flash memory, NOR flash memory, phase-change RAM (PRAM), resistive RAM (ReRAM), ferroelectric RAM (FRAM), spin transfer torque magnetic RAM (STT-MRAM), and the like.

The memory controller 1100 and memory device 1200 may be integrated into a single semiconductor device to form a memory card. For example, the memory controller 1100 and memory device 1200 may be integrated into a single semiconductor device to configure a memory card, such as a personal computer memory card international association (PCMCIA), compact flash card (CF), smart media card (SM, SMC), memory stick, multimedia card (MMC, RS-MMC, MMCmicro, and eMMC), SD card (SD, miniSD, microSD, and SDHC), universal flash memory (UFS), or the like.

The memory controller 1100 may decode the attribute data included in the range data to obtain a priority value, as described with reference to FIGS. 2-8. The memory controller 1100 may sort a plurality of logical address ranges based on the priority value and may determine the order of trim operations between the plurality of logical address ranges based on the sorted result.

Further, the memory controller 1100 may select the trim operation of the logical address ranges as foreground or background, considering the size of each logical address range and its relationship with the restricted performance degradation value.

In this way, the memory controller 1100 may minimize performance degradation by suppressing a decrease in overall system throughput while preferentially performing trim operations for logical address ranges frequently used by the host.

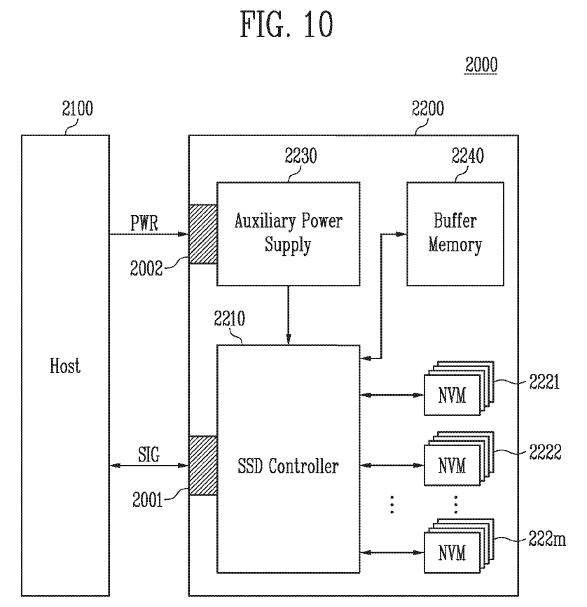

FIG. 10 is a block diagram illustrating a solid state drive (SSD) system to which a storage device according to embodiments of the present disclosure is applied.

Referring to FIG. 10, an SSD system 2000 may include a host 2100 and an SSD 2200. The SSD 2200 may exchange signals SIG with the host 2100 through a signal connector 2001 and receive a power source PWR through a power connector 2002. The SSD 2200 may include an SSD controller 2210, a plurality of flash memories 2221 to 222m, an auxiliary power supply 2230, and a buffer memory 2240, where m may be a natural number greater than 1.

The SSD controller 2210 may decode the attribute data included in the range data to obtain a priority value, as described with reference to FIGS. 2-8. The SSD controller 2210 may sort a plurality of logical address ranges based on the priority value and may determine the order of trim operations between the plurality of logical address ranges based on the sorted result.

Further, the SSD controller 2210 may select the trim operation of the logical address ranges as foreground or background, considering the size of each logical address range and its relationship with the restricted performance degradation value.

In this way, the SSD controller 2210 may minimize performance degradation by suppressing a decrease in throughput of the entire SSD 2200 while preferentially performing trim operations for logical address ranges frequently used by the host 2100.

The SSD controller 2210 may control the plurality of flash memories 2221 to 222m in response to a signal SIG received from the host 2100. For example, the signal SIGs may be signals based on interfaces of the host 2100 and the SSD 2200. For example, the signal SIG may be a signal defined by at least one of communication standards or interfaces, such as USB (Universal Serial Bus), MMC (Multi-Media Card), eMMC (embedded MMC), PCI (peripheral component interconnection), PCI-E (PCI-express), ATA (Advanced Technology Attachment), Serial-ATA, Parallel-ATA, SCSI (small computer system interface), ESDI (enhanced small disk interface), IDE (Integrated Drive Electronics), Firewire, UFS (Universal Flash Storage), WIFI, Bluetooth, NVMe, and the like.

The auxiliary power supply 2230 may be connected to the host 2100 through the power connector 2002. The auxiliary power supply 2230 may receive a power source PWR from the host 2100 and may be charged. The auxiliary power supply 2230 may provide a power source to the SSD 2200 when the power supply from the host 2100 is unreliable. For example, the auxiliary power supply 2230 may be located within the SSD 2200 or may be located outside of the SSD 2200. For example, the auxiliary power supply 2230 may be located on a main board and may provide an auxiliary power source to the SSD 2200.

The buffer memory 2240 may serve as a buffer memory for SSD 2200. For example, the buffer memory 2240 may temporarily store data received from the host 2100 or data received from the plurality of flash memories 2221 to 222m, or may temporarily store metadata (e.g., a mapping table) of the plurality of flash memories 2221 to 222m. The buffer memory 2240 may include volatile memory, such as DRAM, SDRAM, DDR SDRAM, LPDDR SDRAM, GRAM, or the like, or non-volatile memory, such as FRAM, ReRAM, STT-MRAM, PRAM, or the like.

According to embodiments of present disclosure, the order of trim operations for logical address ranges may be controlled by considering a priority value included in a trim command. Therefore, trim operations for frequently used ranges may be preferentially processed while preventing overall system performance degradation.

The embodiments included herein are illustrative of the technical ideas of this disclosure, not limiting the technical ideas of this disclosure, and the scope of the technical ideas of this disclosure is not limited by these embodiments. The scope of protection of this disclosure shall be construed by the following claims, and all technical ideas of equal scope shall be construed to be included within the scope of this disclosure. Furthermore, the embodiments may be combined to form additional embodiments.

What is claimed is:

1. A memory controller configured:
to receive a trim command from a host, the trim command instructing to read range data corresponding to a plurality of logical address ranges, and
to sequentially invalidate mapping information corresponding to the plurality of logical address ranges in an order determined according to priority information included in the range data.

2. The memory controller of claim 1, further configured:
to read the range data corresponding to the plurality of logical address ranges from a memory of the host, based on a number of ranges defined in a control field included in the trim command.

3. The memory controller of claim 2, further configured to read, when the number of ranges defined in the control field is set to N, (N+1) pieces of range data corresponding to (N+1) logical block address ranges from the host.

4. The memory controller of claim 2, wherein the range data includes a start logical address, a range length, and attribute data of a logical address range, and the attribute data includes a priority value indicating the priority information.

5. The memory controller of claim 4, further configured:
to sort the plurality of logical address ranges based on the priority value, and
to determine, for each of the plurality of logical address ranges according to the sorted order, an operating method as either a foreground operation or a background operation based on a size of the corresponding logical address range.

6. The memory controller of claim 5, wherein the size of each of the plurality of logical address ranges is determined based on a range length or an invalidation data size of each of the plurality of logical address ranges.

7. The memory controller of claim 6, wherein the operating methods for the plurality of logical address ranges are determined starting from a logical address range having a higher priority value.

8. The memory controller of claim 7, further configured:
to determine the operating method of a smaller logical address range in preference to a larger logical address range when the plurality of logical address ranges have the same priority value.

9. The memory controller of claim 6, further configured:
to transmit, to the host, a completion signal indicating completion of the trim command after determining the operating method for the logical address range having a lowest priority value in a result of the sorting.

10. The memory controller of claim 9, further configured:
to determine the operating method of a target logical address range as the foreground operation when a size of the target logical address range among the plurality of logical address ranges is less than a reference value, and
to determine the operating method of the target logical address range as the background operation when the size of the target logical address range is greater than or equal to the reference value.

11. The memory controller of claim 10, further configured:
to register the target logical address range, for which the operating method is determined as the background operation, in a background queue, and
to invalidate the mapping information of each of the logical address ranges registered in the background queue after transmitting the completion signal.

12. The memory controller of claim 11, further configured:
to redetermine the operating method for the target logical address range as the background operation for the target logical address range for which the operating method is determined as the foreground operation, when a cumulative throughput reduction rate up to the target logical address range exceeds a restricted performance degradation value.

13. The memory controller of claim 12, further configured:
to maintain the operating method for the target logical address range as the foreground operation for the target logical address range for which the operating method is determined as the foreground operation, when the cumulative throughput reduction rate up to the target logical address range does not exceed the restricted performance degradation value.

14. The memory controller of claim 13, further configured:
to invalidate the mapping information corresponding to the target logical address range prior to transmitting the completion signal, for the target logical address range for which the operating method is determined as the foreground operation.

15. The memory controller of claim 14, wherein the restricted performance degradation value is a value defined in the control field of the trim command.

16. An operating method of a memory controller managing mapping information indicating a correspondence between a logical address managed by a host and a physical address of a memory device, the operating method comprising:
receiving a trim command instructing to read range data specifying a plurality of logical address ranges from the host;
reading the range data corresponding to the plurality of logical address ranges from a memory of the host based on a control field included in the trim command;
sorting the plurality of logical address ranges based on priority information included in the range data; and
sequentially invalidating the mapping information corresponding to each of the plurality of logical address ranges in an order corresponding to a result of the sorting.

17. The operating method of claim 16, further comprising:
selecting a target logical address range with a highest priority value indicating the priority information according to the sorted result;
performing a foreground operation when a size of the target logical address range is less than a reference value; and
performing a background operation when the size of the target logical address range is greater than or equal to the reference value.

18. The operating method of claim 17, further comprising:
transmitting a completion signal indicating a completion status of the trim command to the host when the target logical address range is the last logical address range of the sorted result.

19. The operating method of claim 18, wherein performing the foreground operation includes:
invalidating the mapping information corresponding to the target logical address range prior to transmitting the completion signal.

20. The operating method of claim 18, wherein performing the background operation includes:
registering the target logical address range in a background queue; and
invalidating the mapping information of each of the logical address ranges registered in the background queue after transmitting the completion signal.
